(19) United States
(12) Patent Application Publication
(10) Pub. No.: US 2026/0227228 A1
(43) Pub. Date: Aug. 6, 2026

(54) ADAPTIVE AXLE LOAD ESTIMATION USING SENSOR FUSION

(71) Applicant: VOLVO TRUCK CORPORATION, GÖTEBORG (SE)

(72) Inventors: Andrew Dwinal, Greensboro, NC (US); Gabriel Einstoss, Greensboro, NC (US)

(21) Appl. No.: 19/046,808

(22) Filed: Feb. 6, 2025

(51) Int. Cl. G01G 19/03; B60W 40/13; G01G 19/02

(52) U.S. Cl. CPC G01G 19/03; B60W 40/13; G01G 19/028

(57) ABSTRACT

A computer system comprising processing circuitry configured to obtain a first load estimate using a first load estimation technique. The processing circuitry is further configured to obtain a second load estimate using a second load estimation technique. The processing circuitry is further configured to select the first load estimate as a load on a vehicle in response to determining that the first load estimate matches with the second load estimate. The processing circuitry is further configured to manage at least one vehicle system based on the first load estimate.

### TECHNICAL FIELD

The disclosure relates generally to vehicle load estimation solutions. In particular aspects, the disclosure relates to adaptive axle load estimation using sensor fusion. The disclosure can be applied to heavy-duty vehicles, such as cars, trucks, buses, and construction equipment, among other vehicle types. Although the disclosure may be described with respect to a particular vehicle, the disclosure is not restricted to any particular vehicle.

### BACKGROUND

Accurate axle load information is useful for both drivers and original equipment manufacturers (OEMs) of heavy-duty vehicles. For OEMs, axle load information can support advanced vehicle features in various vehicle systems, such as an anti-lock braking system (ABS), a traction control system, and/or a load distribution optimization system. For drivers, axle load information can ensure compliance with governmental and local regulations, providing confidence that axle loads are within legal limits. However, current load estimation solutions are generally inaccurate, prohibitively expensive, or invasive when implemented as non-OEM aftermarket systems.

### SUMMARY

According to a first aspect of the disclosure, a computer system comprising processing circuitry is configured to obtain a first load estimate using a first load estimation technique. The processing circuitry is further configured to obtain a second load estimate using a second load estimation technique. The processing circuitry is further configured to select the first load estimate as a load on a vehicle in response to determining that the first load estimate matches with the second load estimate. The processing circuitry is further configured to manage at least one vehicle system based on the first load estimate. The first aspect of the disclosure may seek to accurately estimate axle load information. A technical benefit may include accurate axle load information which can support various vehicle systems, such as an anti-lock braking system (ABS), a traction control system, and/or a load distribution optimization system, and can be useful in ensuring compliance with governmental and local regulations. Further, by using multiple estimation techniques, the likelihood of failure over time may be reduced compared to a solution that uses a single method of load measurement.

Optionally in some examples, including in at least one preferred example, the processing circuitry is further configured to: perform the first load estimate technique comprising determining a load based on a suspension force, wherein the suspension force is estimated using a pressure value at a rear axle of the vehicle, a displacement of the rear axle of the vehicle, and a displacement of a front axle of the vehicle.

Optionally in some examples, including in at least one preferred example, the first load estimate technique further comprises: determining another load based on a driveline torque, wherein the driveline torque is estimated using an axle speed of the vehicle, a tire dimension of the vehicle, and a fuel consumption of the vehicle; and determining the first load estimate by applying a factor of difference between the load determined based on the suspension force and the another load determined based on the driveline torque to the load determined based on the suspension force.

Optionally in some examples, including in at least one preferred example, the factor of difference is determined based on first dynamic weights associated with the load determined based on the suspension force and the another load determined based on the driveline torque.

Optionally in some examples, including in at least one preferred example, the first dynamic weights are determined using an averaging filter, an adaptive filter, or a Kalman filter technique.

Optionally in some examples, including in at least one preferred example, the processing circuitry is further configured to: perform the second load estimate technique comprising estimating a suspension force acting on at least one axle of the vehicle.

Optionally in some examples, including in at least one preferred example, the second load estimate technique further comprises measuring a brake force acting on the at least one axle of the vehicle while the vehicle is decelerating; and determining the second load estimate on the at least one axle based on the suspension force and the brake force.

Optionally in some examples, including in at least one preferred example, determining the second load estimate on the at least one axle based on the suspension force and the brake force comprises using second dynamic weights associated with the suspension force and the brake force.

Optionally in some examples, including in at least one preferred example, the second dynamic weights are determined using an averaging filter, an adaptive filter, or a Kalman filter technique.

Optionally in some examples, including in at least one preferred example, the processing circuitry is further configured to: when the first load estimate does not match with the second load estimate: determine a ratio between the second load estimate and the first load estimate; and apply the determined ratio to the first load estimate for estimating the load on the at least one axle of the vehicle to manage the at least one vehicle system.

Optionally in some examples, including in at least one preferred example, the at least one vehicle system comprises an ABS, a traction control system, or an axle load distribution system.

Optionally in some examples, including in at least one preferred example, a vehicle comprises the computer system of any of the examples described above.

According to a second aspect of the disclosure, a computer-implemented method for estimating a load on a vehicle to manage at least one vehicle system includes obtaining, by processing circuitry of a computer system, a first load estimate using a first load estimation technique. The computer-implemented method further includes obtaining, by the processing circuitry, a second load estimate using a second load estimation technique. The computer-implemented method further includes selecting, by the processing circuitry, the first load estimate as the load on the vehicle in response to determining that the first load estimate matches with the second load estimate. The computer-implemented method further includes managing, by the processing circuitry, the at least one vehicle system based on the first load estimate. A technical benefit may include accurate axle load information which can support various vehicle systems, such as an ABS, a traction control system, and/or a load distribution optimization system, and can be useful in ensuring compliance with governmental and local regulations. Further, by using multiple estimation techniques, the likelihood of failure over time may be reduced compared to a solution that uses a single method of load measurement.

Optionally in some examples, including in at least one preferred example, performing the first load estimate technique comprises determining a load based on a suspension force, wherein the suspension force is estimated using a pressure value at a rear axle of the vehicle, a displacement of the rear axle of the vehicle, and a displacement of a front axle of the vehicle.

Optionally in some examples, including in at least one preferred example, performing the first load estimate technique further comprises determining another load based on a driveline torque, wherein the driveline torque is estimated using an axle speed of the vehicle, a tire dimension of the vehicle, and a fuel consumption of the vehicle; and determining the first load estimate by applying a factor of difference between the load determined based on the suspension force and the another load determined based on the driveline torque to the load determined based on the suspension force.

Optionally in some examples, including in at least one preferred example, performing the second load estimate technique comprises estimating a suspension force acting on at least one axle of the vehicle.

Optionally in some examples, including in at least one preferred example, performing the second load estimate technique further comprises measuring a brake force acting on the at least one axle of the vehicle while the vehicle is decelerating; and determining the second load estimate on the at least one axle based on the suspension force and the brake force.

Optionally in some examples, including in at least one preferred example, the computer-implemented method further comprises when the first load estimate does not match with the second load estimate: determining a ratio between the second load estimate and the first load estimate; and applying the determined ratio to the first load estimate for estimating the load on the at least one axle of the vehicle to manage the at least one vehicle system.

Optionally in some examples, including in at least one preferred example, a computer program product comprises program code for performing, when executed by the processing circuitry, the method of any of the method examples described above.

Optionally in some examples, including in at least one preferred example, a non-transitory computer-readable storage medium comprises instructions, which when executed by the processing circuitry, cause the processing circuitry to perform the method of any of the method examples described above.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary vehicle according to an example.

FIG. 2 is an exemplary load estimation unit according to an example.

FIG. 3A is a visual representation of an exemplary load estimation technique according to an example.

FIG. 3B is a diagram of a swing-arm air suspension configuration using two suspension bellows according to an example.

FIG. 4 is an exemplary flow chart of a method to estimate a load according to an example.

FIG. 5 is an exemplary flow chart of a method to perform a first load estimate technique according to an example.

FIG. 6 is an exemplary flow chart of a method to perform a second load estimate technique according to an example.

FIG. 7 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

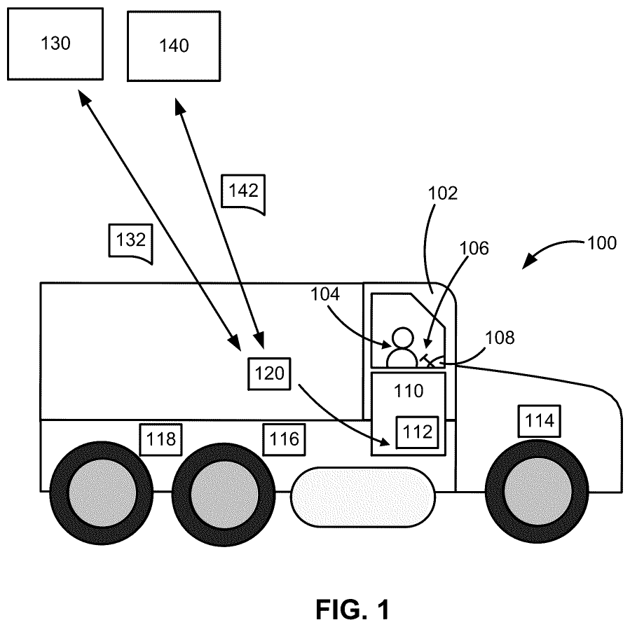

FIG. 1 is an exemplary vehicle in which the various aspects of the disclosure may be used according to one example. FIG. 1 illustrates a truck 100 having a cab 102 used by a vehicle user 104. A vehicle electronic control unit (ECU) 110 controls the vehicle 100 responsive to commands by the vehicle user 104 via steering wheel 106 and dashboard 108. The ECU 110 can include or communicate with a load estimation unit (LEU) 112. The LEU 112 may receive or obtain vehicle information, load related information, and/or other data from one or more vehicle systems, e.g., an engine management system (EMS) 114, an electronically controlled suspension system (ECS) 116 (also referred to herein as an electronic suspension controller), and/or an electronic braking system (EBS) 118. For example, a vehicle communication interface (VCI) 120 may include a network, a bus, or a mechanism for facilitating communications between various entities, such as vehicle systems, ECU 110, LEU 112, and/or other entities (e.g., a remote technician or diagnostic operator) or components (e.g., sensors or modules).

In some examples, systems or entities (e.g., a remote operator) may need to be authenticated and authorized before being allowed to provide commands or data to various parts (e.g., modules) of the vehicle 100. FIG. 1 also illustrates an authentication server 130 and an authorization server 140 that communicates with the VCI 120 to provide the authentication 132 and authorization 142, respectively. While shown separately, the authentication server 130 and authorization server 140 may be part of a same network node, be part of vehicle ECU 110, be part of a same network server node being in a client server relationship with client components located as part of vehicle ECU 110.

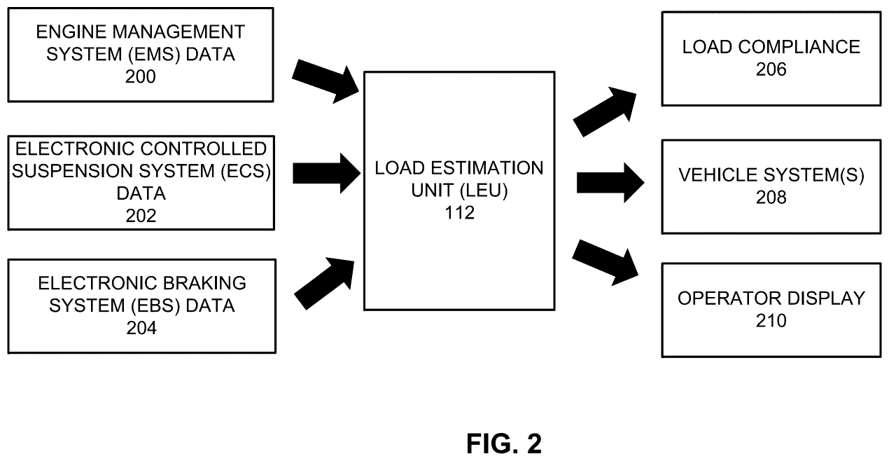

FIG. 2 is an exemplary LEU 112 according to an example. In some examples, the LEU 112 may obtain data from various vehicle systems (e.g., EMS data 200, ECS data 202, and/or EBS data 204), may use this data in estimating a load of the vehicle 100 (e.g., a total mass or weight of the vehicle, one or more axle loads, etc.), and may provide the estimated load to one or more entities for various purposes, e.g., load compliance 206, vehicle systems 208, operator display 210, etc.

In some examples, the EMS data 200 may be utilized and/or indicate an estimated load (e.g., total vehicle and trailer weight) of the vehicle via a particular technique. In some examples, the EMS 114 may use transmission and engine data to calculate the torque output to a propeller shaft (also known as a prop shaft or drive shaft) and may provide this output and/or other data to the LEU 112 or other entities. In some examples, the EMS data 200 (e.g., torque output) indicating resistance to motion may be used in estimating load during acceleration, e.g., the load may represent the total vehicle and trailer weight. In some examples, the EMS data 200 provided to the LEU 112 may include or indicate the estimated load during acceleration.

In some examples, the ECS data 202 may be utilized and/or indicate an estimated load of the vehicle (e.g., axle load(s) for one or more axles) via a particular technique. In some examples, the ECS 116 may measure pressure in air bellow(s) and estimate the effective area of the air bellow(s) with respect to other properties (displacement, pressure, angle to frame). In some examples, the ECS data 202 (e.g., a pressure value at a rear axle of the vehicle, a displacement of the rear axle of the vehicle, and a displacement of a front axle of the vehicle) may be used to calculate a force on the ground and to estimate an axle load. In some examples, the ECS data 202 provided to the LEU 112 may include the estimated axle load for one or more axles (e.g., axle loads for each rear axle of the vehicle 100).

In some examples, the EBS data 206 may be utilized and/or indicate an estimated load of the vehicle (e.g., axle load(s) for one or more axles) via a particular technique. In some examples, the EBS 118 may apply pressure to wheel end brakes and calculate force in the respective brake chambers and then using that information calculate a torque on the wheel. In some examples, the torque may be used to determine brake force on the ground, which is directly related to mass on the ground with respect to that wheel end. In some examples, the deceleration and slip of each wheel may be used to estimate the normal load on that tire. In some examples, the estimated loads for a set of tires may be used to determine an estimated load for the respective axle. In some examples, the EBS data 204 provided to the LEU 112 may include the estimated axle load for one or more axles (e.g., axle loads for each rear axle of the vehicle 100).

In some examples, a load estimation technique (e.g., performed by or using the LEU 112) may involve obtaining estimated loads determined by three different techniques and processing (e.g., combining or analyzing) the estimated loads to obtain or derive a single set of values representing each axle load. In some examples, the processing of different estimated loads or related aspects may be referred to as sensor fusion.

In some examples, a load estimation technique (e.g., performed by or using the LEU 112) may perform sensor fusion to determine an accurate estimated load from multiple load estimation techniques. In some examples, the fusion-based technique may prioritize highly auto-correlated signals (e.g., estimated loads or related data by techniques that have enough data to confirm accuracy) while giving less weight to signals with greater variability (e.g., estimated loads generated by techniques that do not have enough data to confirm accuracy). By integrating multiple estimation techniques and accounting for uncertainty, the fusion-based technique can produce a more accurate load measurement than any of the estimation techniques alone. In some examples, the fusion-based technique or process may dynamically adjust the weighting of different load estimation technique based on auto-correlation and cross-correlation between inputs. In some examples, sensor fusion techniques may include or use an averaging filter, an adaptive filter, or a Kalman filter.

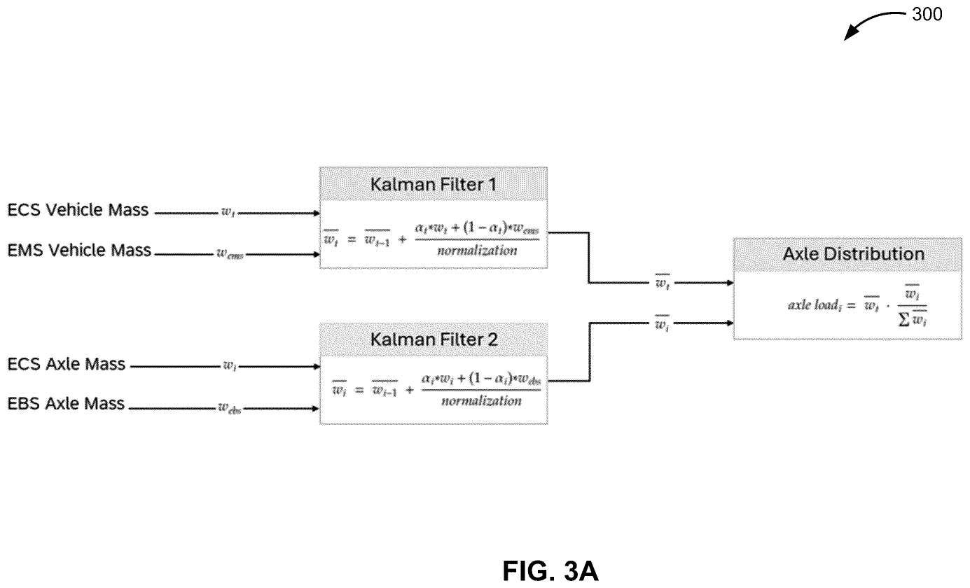

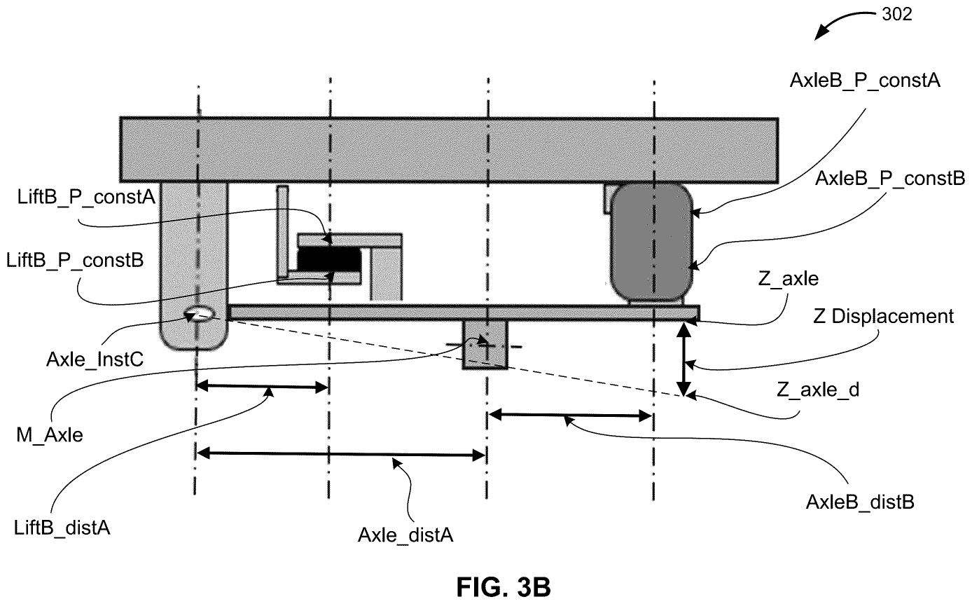

FIG. 3A is a visual representation of an exemplary load estimation technique 300 according to an example. In some examples, the load estimation technique 300 may be a fusion-based technique that utilizes loads (e.g., vehicle mass or weight, axle mass or loads, etc.) or data from different vehicle systems, e.g., the EMS 114, the ECS 116, and the EBS 118.

A set of abbreviations and terms associated with FIG. 3A are defined below:
ECS=Electronically Controlled Suspension System or Electronic Suspension Controller
EMS=Engine Management System
EBS=Electronic Braking System
ωₜ=total vehicle mass on the ground from ECS
ω̅ₜ̅=weighted wₜ
ωₑₘₛ=total vehicle mass on the ground from EMS
ωᵢ=individual axle load on the ground from ECS
ω̅ᵢ̅=weighted wᵢ
ω_{ebs}=individual axle load on the ground from EBS
mₐᵢ=unsprung mass of axle i
g=9.81 m/s²
Aₑ=effective area of air bellow
Pᵢ=pressure in bellow (Pa) associated with axle i
RAᵢ=rear axle i
ατ=f(Rxy(ECS, EMS))=correlation of inputs
αᵢ=f(Rxy(ECS, EBS))=correlation of inputs

$${ω}_{t} = \sum {ω}_{i} = {\frac{1}{g} [ {P}_{i} * {A}_{e} + {m}_{a 1} g ]}_{R A 1} + {\frac{1}{g} [ {P}_{i} * {A}_{e} + {m}_{a 2} g ]}_{R A 2} +$$

In some examples, the formula for computing total vehicle mass may be based on various factors, such as the position or location of suspension bellows. For example, the formula

$${ω}_{t} = \sum {ω}_{i} = {\frac{1}{g} [ {P}_{i} * {A}_{e} + {m}_{a 1} g ]}_{R A 1} + {\frac{1}{g} [ {P}_{i} * {A}_{e} + {m}_{a 2} g ]}_{R A 2} + front axle weight$$

may be valid or usable in computing the total vehicle mass if the suspension bellow is vertically supporting the mass (e.g., vertically suspending the mass). However, in some examples, some suspension bellows may be positioned at the end of a torque arm, where an axle is mounted about halfway between the suspension bellow and the mounting point (e.g., fulcrum) of the suspension arm. In such configurations, a torque-based equation or ratio may be used to calculate the force on the wheel due to the pressure within the suspension bellow.

In some examples, the formula

$${ω}_{t} = \sum {ω}_{i} = {\frac{1}{g} [ {P}_{i} * {A}_{e} + {m}_{a 1} g ]}_{R A 1} + {\frac{1}{g} [ {P}_{i} * {A}_{e} + {m}_{a 2} g ]}_{R A 2} + front axle weight$$

may indicate relationships between different types of load estimations. For example, wₜ is the total weight of the vehicle and may be determined by summing the individual axle weights of the vehicle 100, where ωᵢ represents individual axle weights. The equation also indicates that particular axle weights may be calculated or obtained differently, e.g., one technique for rear axles and another technique for a front axle.

In some examples, the weight contribution for each rear axle is calculated by

$${\frac{1}{g} [ {P}_{i} * {A}_{e} + {m}_{a i} g ]}_{R A i} ,$$

where Pᵢ is the pressure in the air bellows (in pascals), and Aₑ is the effective area of the air bellows. In some examples, the Pᵢ and Aₑ values may be provided or derived from data provided by one or more vehicle systems, such as the ECS 116. The expression Pᵢ*Aₑ represents the force exerted by air pressure in the suspension system. Additionally, mₐᵢ is the unsprung mass of axle i, and mₐᵢg accounts for the gravitational force acting on that mass, with g=9.81 m/s² being the acceleration due to gravity. Dividing by g converts the force terms into equivalent weight contributions. The subscripts RA1 and RA2 specify that these terms correspond to the rear axles 1 and 2, respectively. The final term in the equation, “front axle weight,” represents the static weight contribution of the front axle, which may be predetermined or determined using various techniques. In some examples, mₐᵢ, g, and/or “front axle weight” values may be predetermined. In some examples, mₐᵢ, g, and/or “front axle weight” values may be provided or derived from data provided by one or more vehicle systems, such as EMS 114.

Turning to FIG. 3A, as depicted, the load estimation technique 300 may utilize two Kalman filters and an axle distribution determination technique. In some examples, when using a Kalman filter, a covariance matrix is used to represent the uncertainty of each input. For instance, when a sensor or its data is used as an input, the variance of the noise associated with that sensor data is used to populate the covariance matrix. In scenarios where an input has higher uncertainty, it is considered less reliable. Consequently, either a predictive model or another input with higher reliability may be biased as the dominant source of information

In some examples, the Kalman filter “1” may be represented by the formula

$$\overline{{ω}_{t}} = \overline{{ω}_{t - 1}} + \frac{{α}_{t} * {ω}_{t} + ( 1 - {α}_{t} ) * {ω}_{e m s}}{normalization} .$$

The Kalman filter “1” may be used to output a total vehicle mass estimate (e.g., a weighted total vehicle mass) and may update the total vehicle mass estimate dynamically, e.g., while the vehicle is either parked or in motion. In some examples, the ω̅ₜ̅ may be computed using integrated historical data (e.g., ω̅ₜ̅₋̅₁̅), current sensor inputs (e.g., ωₑₘₛ and ωₜ), and dynamic weighting based on input correlations. In the formula of Kalman filter “1”, ω̅ₜ̅ is the weighted total vehicle mass at the current time step and ω̅ₜ̅₋̅₁̅ is the weighted total vehicle mass at the previous time step. The ωₜ represents the total vehicle mass estimated by the ECS 116 and the ωₑₘₛ represents the total vehicle mass estimated by the EMS 114. The weighting factor at represents a correlation factor based on the relationship between ECS and EMS inputs, and can dynamically adjust the contribution of ωₑₘₛ and ωₜ to the ω̅ₜ̅ estimate. The complementary term (1−αₜ) may ensure the weights are balanced and the normalization may represent a normalization factor that scales the combined values appropriately, e.g., to main accuracy.

In some examples, the Kalman filter “1” may receive ECS vehicle mass data, e.g., ωₜ representing total vehicle mass on the ground determined by the ECS 116. In some examples, the ECS 116 may estimate the load that each axle of the vehicle 100 puts on the ground, including both the sprung and unsprung masses. In some examples, this estimated total vehicle mass may be determined by reading air pressure in the suspension bellows and calculating the sprung mass, then adding the unsprung mass (e.g., a predetermined or known value) to give a total weight on the ground per axle. In some examples, the ECS vehicle mass data may be initialized as a lower variance input to the Kalman filter “1”, e.g., relative to EMS vehicle mass data.

In some examples, the Kalman filter “1” may also receive EMS vehicle mass data, e.g., ωₑₘₛ representing total vehicle mass on the ground determined by the EMS 114. In some examples, the EMS 114 may estimate the total vehicle load (e.g., total vehicle mass or weight) by monitoring fuel input during acceleration and estimating the force needed to produce motion. In some examples, the EMS vehicle mass data may be initialized as a higher variance input to the Kalman filter “1”, e.g., relative to ECS vehicle mass data. In some examples, the EMS vehicle mass data may be essentially ignored in the Kalman filter until the EMS vehicle mass data converges to a well correlated signal. Once the EMS vehicle mass data converges (e.g., after the EMS have had time to accurately estimate the load and the estimated load has settled to a plausible value), then the covariance will reflect the current estimate and the filter will combine the two inputs based on the signal quality. In some examples, the covariance will be reset if notable changes are detected, e.g., resulting, at least initially, in the EMS vehicle mass data being ignored by the Kalman filter “1” and the Kalman filter's output only reflecting ECS estimates.

In some examples, the Kalman filter “2” may be represented by

$$\overline{{w}_{i}} = \overline{{w}_{i - 1}} + \frac{{α}_{i} * {w}_{i} + ( 1 - {α}_{i} ) * {W}_{ebs}}{normalization} .$$

The Kalman filter “2” may be used to output an individual axle mass estimate (e.g., a weighted individual axle load or weight) and may update the estimate dynamically, e.g., whether the vehicle is stationary or in motion. In some examples, the di may be computed using integrated historical data (e.g., ω̅ᵢ̅₋̅₁̅), current sensor inputs (e.g., ω_{ebs} and ωᵢ), and dynamic weighting based on input correlations. In the formula of Kalman filter “2”, ω̅ᵢ̅ is the weighted axle mass at the current time step and ω̅ᵢ̅₋̅₁̅ is the weighted axle at the previous time step. The ωᵢ represents the axle mass (e.g., axle load) estimated by the ECS 116 and the Webs represents the axle mass estimated by the EBS 118. The weighting factor αᵢ represents a correlation factor based on the relationship between ECS and EBS inputs, and can dynamically adjust the contribution of ω_{ebs} and ωᵢ to the w̅ᵢ̅ estimate. The complementary term (1−αᵢ) may ensure the weights are balanced and the normalization may represent a normalization factor that scales the combined values appropriately, e.g., to main accuracy.

In some examples, the Kalman filter “2” may estimate individual axle loads with respect to the combined total axle loads and may indicate a percentage of vehicle mass distribution between axles. In some examples, the Kalman filter “2” may receive ECS axle mass data, e.g., ωᵢ representing individual axle load(s) on the ground determined by the ECS 116. In some examples, the ECS axle mass data may be the dominant sensor input initially, and the EBS axle mass data may be given high uncertainty (e.g., a higher variance input). The EBS axle mass data may converge to indicate accurate axle loads by estimating wheel end loads. To determine accurate axle loads, the EBS 118 may apply pressure to wheel end brakes and calculate force in the respective brake chambers and then using that information calculate a torque on the wheel. In some examples, the torque may be used to determine brake force on the ground, which is directly related to mass on the ground with respect to that wheel end. In some examples, the deceleration and slip of each wheel may be used to estimate the vehicle mass and the mass at each wheel end by solving for the normal force to the ground. In some examples, the force at each wheel end determined by the EBS 118 may be used in the Kalman filter “2” to update the individual axle loads by combining wheel ends of the same axle. When the EBS axle mass data converge to plausible values, then the covariance will reflect the current estimate and the filter will combine the two inputs (e.g., the EBS axle mass and the ECS axle mass) based on the signal quality to more accurately estimate the individual axle loads. In some examples, the covariance will be reset if notable changes are detected, e.g., resulting, at least initially, in the EBS axle mass data being ignored by the Kalman filter “2” and the Kalman filter's output only reflecting ECS estimates.

In some examples, the axle distribution determination technique of the load estimation technique 300 be represented by the formula

$${\overline{axle load}}_{i} = \overline{{w}_{t}} * \frac{\overline{{w}_{i}}}{\sum \overline{{w}_{i}}} .$$

The formula may be used to compute the load on an individual axle based on the total vehicle mass and the relative distribution of weight across all axles. In this formula, ω̅ₜ̅ represents the weighted total vehicle mass, and ω̅ᵢ̅ represents the weighted load for the specific axle i. The term Σw̅ᵢ̅ represents the sum of weighted axle loads across all axles, ensuring that the distribution reflects the proportional share of the total mass. This formula can provide a dynamically calculated axle load by scaling the total vehicle mass (e.g., ω̅ₜ̅ from Kalman filter “1”) according to the relative weight contributions of each axle

$$( e . g . , \frac{\overline{{w}_{i}}}{\sum \overline{{w}_{i}}} ) .$$

In some examples, the axle distribution technique is adaptable to changing conditions and can integrate updated inputs for ω̅ₜ̅ and ω̅ᵢ̅. In some examples, this formula and approach may ensure that the calculated axle load aligns with the total mass and the distribution of weight across the axles.

In some examples, the axle distribution determination technique may utilize the outputs of each Kalman filter, e.g., a weighted total vehicle mass from the Kalman filter “1” and individual axle loads from the Kalman filter “2”, to calculate the final output, e.g., individual axle loads. In some examples, the individual axle loads may be divided by the combined sum of the Kalman filter “2” to give a ratio of each axle load to the total vehicle mass with respect to the Kalman filter “2”.

FIG. 3B is a diagram 302 of a swing-arm air suspension configuration using two suspension bellows according to an example. As stated above, formulas for computing the total vehicle mass may vary depending on the vehicle and its air suspension configuration, such as the swing-arm air suspension configuration depicted in the diagram 302. In the diagram 302, the top bar represents the vehicle chassis, with a pivot point on the right end allowing the main swing arm to rotate up and down. The axle is shown near the left side, secured below the swing arm, and the dimensions, such as Axle_distA and AxleB_distB, mark reference distances between the axle, lift bellows, and pivot. The two bellows, labeled LiftB_P and AxleB_P, provide the air-spring support, helping absorb road shocks and maintain ride height as the swing arm moves. The rectangular block around the center represents the axle mounting bracket (M_Axle), and Axle_InstC indicates the axle attachment point on the arm. The distances noted (LiftB_distA and others) show how the components' positions relate to one another, illustrating how this swing-arm arrangement leverages air bellows to control suspension travel.

In some examples, axle force as a function of bellow pressure may be defined by the lift bellow force and the axle bellow force. The lift bellow force is given by F_LiftB=P(bar)*(LiftB_P_constA+(P(bar)*LiftB_P_constB)), and the main axle bellow force is defined by F_AxleB=P(bar)*(AxleB_P_constA+(P(bar)*AxleB_P_constB)). In this configuration, P(bar) represents the internal bellow pressure in bar, while LiftB_P_constA, LiftB_P_constB, AxleB_P_constA, and AxleB_P_constB are constants (e.g., predetermined values) usable by the formula(s).

In some examples, the torque equation may be used to calculate the force from the axle to the ground. In some examples, the torque equation may be represented as F_LiftB*LiftB_distA+F_AxleB*AxleB_distB−(M_Axle*g*Axle_distA)−(Axle_InstC*(Z_axle_d-Z_axle))*Axle_distA+F_axle*Axle_distA=0. In such examples, M_Axle*g is the axle's weight, Axle_distA is the distance from the pivot to the axle, and Axle_InstC*(Z_axle_d-Z_axle) represents constraints related to the difference between the desired and actual axle heights. In some examples, the Z displacement portion (e.g., (Z_axle_d-Z_axle)) of the above torque equation may account for the force variation due to the torque arm's angular deviation from the horizontal. In some examples, the Z displacement portion may be optional to calculate the force from the axle to the ground. For instance, an alternative torque equation might use a constant value in place of the Z displacement term or omit it entirely.

In some examples, the torque equation may be used to derive a formula for the net axle force by isolating F_axle, such as F_axle=(M_Axle*g+F_AxleB*(Axle_distA+AxleB_distB)−F_LiftB*LiftB_distA-Axle_InstC*(Z_axle_d-Z_axle)*Axle_distA)/Axle_distA.

In some examples, the axle force contribution from each bellow can be determined separately by considering the respective lever arms. For example, for the lift bellow, the partial axle force may be determined by F_axle_liftbellow=−F_LiftB*LiftB_distA/Axle_distA, and may indicate how the lift bellow force transfers through its distance from the pivot. For the main axle bellow, the partial axle force may be determined by F_axle_axleBellow=FAxleB*(Axle_distA+AxleB_distB)/Axle_distA, and may indicate how that bellow's position influences the net force on the axle.

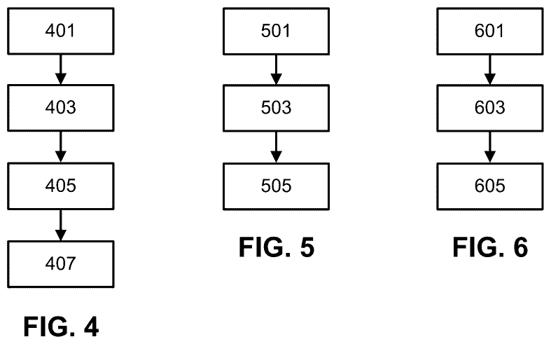

FIG. 4 is an exemplary flow chart of a method to estimate a load according to an example. In some examples, the LEU 112, the ECU 110, or processing circuitry of a computer system may estimate a load comprising one or more aspects depicted in FIG. 4. In some examples, estimating a load may be based on or derived from data or information obtained from various vehicles systems, e.g., the EMS 114, the ECS 116, and/or the EBS 118, or sensors therein. In some examples, the method depicted in FIG. 4 includes blocks 401-405 below.

Turning to FIG. 4, in block 401, the method includes obtaining a first load estimate using a first load estimation technique. In some examples, the first load estimation technique or aspects thereof may be performed by a vehicle system (e.g., the EMS 114, the ECS 116, etc.), e.g., using EMS data 200 or ECS data 202. In some examples, the first load estimate or related data may be obtained or retrieved from the EMS 114, the ECS 116, or data storage. In some examples, the first load estimation technique may be performed by the LEU 112, the ECU 110, or processing circuitry of a computer system and may utilize EMS data 200 and ECS data 202.

In block 403, the method further includes obtaining a second load estimate using a second load estimation technique. In some examples, the second load estimation technique or aspects thereof may be performed by a vehicle system (e.g., the ECS 116, the EBS 118, etc.), e.g., using ECS data 202 or EBS data 204. In some examples, the second load estimate or related data may be obtained or retrieved from the ECS 116, the EBS 118, or data storage. In some examples, the second load estimation technique may be performed by the LEU 112, the ECU 110, or processing circuitry of a computer system and may utilize ECS data 202 and EBS data 204.

In block 405, the method further includes selecting the first load estimate as a load on a vehicle in response to determining that the first load estimate matches with the second load estimate.

In block 407, the method further includes managing at least one vehicle system based on the first load estimate.

FIG. 5 is an exemplary flow chart of a method to perform a first load estimate technique according to an example. In some examples, the LEU 112, the ECU 110, or processing circuitry of a computer system may perform a first load estimate technique comprising one or more aspects depicted in FIG. 5.

Turning to FIG. 5, in block 501, performing the first load estimate technique may include determining a load based on a suspension force, wherein the suspension force is estimated using a pressure value at a rear axle of the vehicle, a displacement of the rear axle of the vehicle, and a displacement of a front axle of the vehicle. In some examples, suspension related information (e.g., a pressure value at a rear axle, a displacement of the rear axle, a displacement of a front axle, etc.) may be provided by the ECS 116 to the LEU 112 or another entity for determining a load based on a suspension force.

In block 503, performing the first load estimate technique may further include determining another load based on a driveline torque, wherein the driveline torque is estimated using an axle speed of the vehicle, a tire dimension of the vehicle, and a fuel consumption of the vehicle. In some examples, engine related information (e.g., an axle speed of the vehicle 100, a tire dimension of the vehicle 100, a fuel consumption of the vehicle 100, etc.) may be provided by the EMS 114 to the LEU 112 or another entity for determining a load based on a driveline torque.

In block 505, performing the first load estimate technique may further include determining the first load estimate by applying a factor of difference between the load determined based on the suspension force and the another load determined based on the driveline torque to the load determined based on the suspension force. In some examples, the LEU 112 or another entity may determine the factor of difference based on dynamic weights associated with the load determined based on the suspension force and the another load determined based on the driveline torque. In some examples, the dynamic weights may be determined using an averaging filter, an adaptive filter, or a Kalman filter technique.

FIG. 6 is an exemplary flow chart of a method to perform a second load estimate technique according to an example. In some examples, the LEU 112, the ECU 110, or processing circuitry of a computer system may perform a second load estimate technique comprising one or more aspects depicted in FIG. 6.

Turning to FIG. 6, in block 601, performing the second load estimate technique may include estimating a suspension force acting on at least one axle of the vehicle. In some examples, suspension related information may be provided by the ECS 116 to the LEU 112 or another entity for estimating a suspension force acting on one or more axles of the vehicle 100.

In block 603, performing the second load estimate technique may further include measuring a brake force acting on the at least one axle of the vehicle while the vehicle is decelerating. In some examples, brake related information may be provided by the EBS 118 to the LEU 112 or another entity for estimating a brake force acting on one or more axles of the vehicle 100, e.g., while the vehicle 100 is decelerating.

In block 605, performing the second load estimate technique may further include determining the second load estimate on the at least one axle based on the suspension force and the brake force. In some examples, the LEU 112 or another entity may determine the second load estimate on the at least one axle based on the suspension force and the brake force using dynamic weights associated with the suspension force and the brake force. In some examples, the dynamic weights may be determined using an averaging filter, an adaptive filter, or a Kalman filter technique.

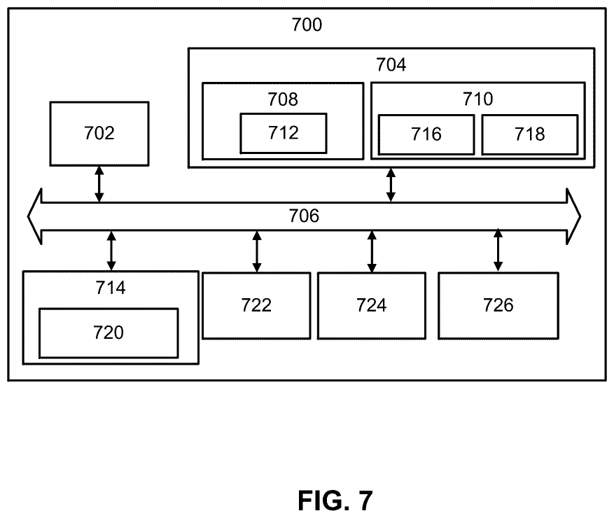

FIG. 7 is a schematic diagram of a computer system 700 for implementing examples disclosed herein. The computer system 700 is adapted to execute instructions from a computer-readable medium to perform these and/or any of the functions or processing described herein. The computer system 700 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 700 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc. In some examples, the computer system 700 may comprise the ECU 110 and/or the LEU 112.

The computer system 700 may comprise at least one computing device or electronic device capable of including firmware, hardware, and/or executing software instructions to implement the functionality described herein. The computer system 700 may include processing circuitry 702 (e.g., processing circuitry including one or more processor devices or control units), a memory 704, and a system bus 706. The computer system 700 may include at least one computing device having the processing circuitry 702. The system bus 706 provides an interface for system components including, but not limited to, the memory 704 and the processing circuitry 702. The processing circuitry 702 may include any number of hardware components for conducting data or signal processing or for executing computer code stored in memory 704. The processing circuitry 702 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 702 may further include computer executable code that controls operation of the programmable device.

The system bus 706 may be any of several types of bus structures that may further interconnect to a memory bus (with or without a memory controller), a peripheral bus, and/or a local bus using any of a variety of bus architectures. The memory 704 may be one or more devices for storing data and/or computer code for completing or facilitating methods described herein. The memory 704 may include database components, object code components, script components, or other types of information structure for supporting the various activities herein. Any distributed or local memory device may be utilized with the systems and methods of this description. The memory 704 may be communicably connected to the processing circuitry 702 (e.g., via a circuit or any other wired, wireless, or network connection) and may include computer code for executing one or more processes described herein. The memory 704 may include non-volatile memory 708 (e.g., read-only memory (ROM), erasable programmable read-only memory (EPROM), electrically erasable programmable read-only memory (EEPROM), etc.), and volatile memory 710 (e.g., random-access memory (RAM)), or any other medium which can be used to carry or store desired program code in the form of machine-executable instructions or data structures and which can be accessed by a computer or other machine with processing circuitry 702. A basic input/output system (BIOS) 712 may be stored in the non-volatile memory 708 and can include the basic routines that help to transfer information between elements within the computer system 700.

The computer system 700 may further include or be coupled to a non-transitory computer-readable storage medium such as the storage device 714, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 714 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 714 and/or in the volatile memory 710, which may include an operating system 716 and/or one or more program modules 718. All or a portion of the examples disclosed herein may be implemented as a computer program 720 stored on a transitory or non-transitory computer-usable or computer-readable storage medium (e.g., single medium or multiple media), such as the storage device 714, which includes complex programming instructions (e.g., complex computer-readable program code) to cause the processing circuitry 702 to carry out actions described herein. Thus, the computer-readable program code of the computer program 720 can comprise software instructions for implementing the functionality of the examples described herein when executed by the processing circuitry 702. In some examples, the storage device 714 may be a computer program product (e.g., readable storage medium) storing the computer program 720 thereon, where at least a portion of a computer program 720 may be loadable (e.g., into a processor) for implementing the functionality of the examples described herein when executed by the processing circuitry 702. The processing circuitry 702 may serve as a controller or control system for the computer system 700 that is to implement the functionality described herein.

The computer system 700 may include an input device interface 722 configured to receive input and selections to be communicated to the computer system 700 when executing instructions, such as from a keyboard, mouse, touch-sensitive surface, etc. Such input devices may be connected to the processing circuitry 702 through the input device interface 722 coupled to the system bus 706 but can be connected through other interfaces, such as a parallel port, an Institute of Electrical and Electronic Engineers (IEEE) 1394 serial port, a Universal Serial Bus (USB) port, an IR interface, and the like. The computer system 700 may include an output device interface 724 configured to forward output, such as to a display, a video display unit (e.g., a liquid crystal display (LCD) or a cathode ray tube (CRT)). The computer system 700 may include a communications interface 726 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Below follows a brief summary of examples herein. Any one or more out of below Examples may be combined with any one or more out of the above examples or embodiments in any suitable manner.

Additional examples include:

Example 1: A computer system comprising processing circuitry configured to: obtain a first load estimate using a first load estimation technique; obtain a second load estimate using a second load estimation technique; select the first load estimate as a load on a vehicle in response to determining that the first load estimate matches with the second load estimate; and manage at least one vehicle system based on the first load estimate.

Example 2: The computer system of example 1, wherein the processing circuitry is further configured to: perform the first load estimate technique comprising determining a load based on a suspension force, wherein the suspension force is estimated using a pressure value at a rear axle of the vehicle, a displacement of the rear axle of the vehicle, and a displacement of a front axle of the vehicle.

Example 3: The computer system of example 2, wherein the first load estimate technique further comprises: determining another load based on a driveline torque, wherein the driveline torque is estimated using an axle speed of the vehicle, a tire dimension of the vehicle, and a fuel consumption of the vehicle; and determining the first load estimate by applying a factor of difference between the load determined based on the suspension force and the another load determined based on the driveline torque to the load determined based on the suspension force.

Example 4: The computer system of example 3, wherein the factor of difference is determined based on first dynamic weights associated with the load determined based on the suspension force and the another load determined based on the driveline torque.

Example 5: The computer system of example 4, wherein the first dynamic weights are determined using an averaging filter, an adaptive filter, or a Kalman filter technique.

Example 6: The computer system of any of examples 1-5, wherein the processing circuitry is further configured to: perform the second load estimate technique comprising estimating a suspension force acting on at least one axle of the vehicle.

Example 7: The computer system of example 6, wherein the second load estimate technique further comprises: measuring a brake force acting on the at least one axle of the vehicle while the vehicle is decelerating; and determining the second load estimate on the at least one axle based on the suspension force and the brake force.

Example 8: The computer system of example 7, wherein determining the second load estimate on the at least one axle based on the suspension force and the brake force comprises using second dynamic weights associated with the suspension force and the brake force.

Example 9: The computer system of example 8, wherein the second dynamic weights are determined using an averaging filter, an adaptive filter, or a Kalman filter technique.

Example 10: The computer system of any of examples 1-9, wherein the processing circuitry is further configured to: when the first load estimate does not match with the second load estimate: determine a ratio between the second load estimate and the first load estimate; and apply the determined ratio to the first load estimate for estimating the load on the at least one axle of the vehicle to manage the at least one vehicle system.

Example 11: The computer system of any of examples 1-10, wherein the at least one vehicle system comprises an anti-lock braking system (ABS), a traction control system, or an axle load distribution system.

Example 12: A vehicle comprising the computer system of any of examples 1-11.

Example 13: A computer-implemented method for estimating a load on a vehicle to manage at least one vehicle system, comprising: obtaining, by processing circuitry of a computer system, a first load estimate using a first load estimation technique; obtaining, by the processing circuitry, a second load estimate using a second load estimation technique; selecting, by the processing circuitry, the first load estimate as the load on the vehicle in response to determining that the first load estimate matches with the second load estimate; and managing, by the processing circuitry, the at least one vehicle system based on the first load estimate.

Example 14: The method of example 13, further comprising: performing the first load estimate technique comprising determining a load based on a suspension force, wherein the suspension force is estimated using a pressure value at a rear axle of the vehicle, a displacement of the rear axle of the vehicle, and a displacement of a front axle of the vehicle.

Example 15: The method of example 14, wherein performing the first load estimate technique further comprises: determining another load based on a driveline torque, wherein the driveline torque is estimated using an axle speed of the vehicle, a tire dimension of the vehicle, and a fuel consumption of the vehicle; and determining the first load estimate by applying a factor of difference between the load determined based on the suspension force and the another load determined based on the driveline torque to the load determined based on the suspension force.

Example 16: The method of any of examples 13-15, further comprising: performing the second load estimate technique comprising estimating a suspension force acting on at least one axle of the vehicle.

Example 17: The method of example 16, wherein performing the second load estimate technique further comprises: measuring a brake force acting on the at least one axle of the vehicle while the vehicle is decelerating; and determining the second load estimate on the at least one axle based on the suspension force and the brake force.

Example 18: The method of any of examples 13-17, further comprising: when the first load estimate does not match with the second load estimate: determining a ratio between the second load estimate and the first load estimate; and applying the determined ratio to the first load estimate for estimating the load on the at least one axle of the vehicle to manage the at least one vehicle system.

Example 19: A computer program product comprising program code for performing, when executed by the processing circuitry, the method of any of examples 13-18.

Example 20: A non-transitory computer-readable storage medium comprising instructions, which when executed by the processing circuitry, cause the processing circuitry to perform the method of any of examples 13-18.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.\

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
obtain a first load estimate using a first load estimation technique;
obtain a second load estimate using a second load estimation technique;
select the first load estimate as a load on a vehicle in response to determining that the first load estimate matches with the second load estimate; and
manage at least one vehicle system based on the first load estimate.

2. The computer system of claim 1, wherein the processing circuitry is further configured to:
perform the first load estimate technique comprising determining a load based on a suspension force, wherein the suspension force is estimated using a pressure value at a rear axle of the vehicle, a displacement of the rear axle of the vehicle, and a displacement of a front axle of the vehicle.

3. The computer system of claim 2, wherein the first load estimate technique further comprises:
determining another load based on a driveline torque, wherein the driveline torque is estimated using an axle speed of the vehicle, a tire dimension of the vehicle, and a fuel consumption of the vehicle; and
determining the first load estimate by applying a factor of difference between the load determined based on the suspension force and the another load determined based on the driveline torque to the load determined based on the suspension force.

4. The computer system of claim 3, wherein the factor of difference is determined based on first dynamic weights associated with the load determined based on the suspension force and the another load determined based on the driveline torque.

5. The computer system of claim 4, wherein the first dynamic weights are determined using an averaging filter, an adaptive filter, or a Kalman filter technique.

6. The computer system of claim 1, wherein the processing circuitry is further configured to:
perform the second load estimate technique comprising estimating a suspension force acting on at least one axle of the vehicle.

7. The computer system of claim 6, wherein the second load estimate technique further comprises:
measuring a brake force acting on the at least one axle of the vehicle while the vehicle is decelerating; and
determining the second load estimate on the at least one axle based on the suspension force and the brake force.

8. The computer system of claim 7, wherein determining the second load estimate on the at least one axle based on the suspension force and the brake force comprises using second dynamic weights associated with the suspension force and the brake force.

9. The computer system of claim 8, wherein the second dynamic weights are determined using an averaging filter, an adaptive filter, or a Kalman filter technique.

10. The computer system of claim 1, wherein the processing circuitry is further configured to:
when the first load estimate does not match with the second load estimate:
determine a ratio between the second load estimate and the first load estimate; and
apply the determined ratio to the first load estimate for estimating the load on the at least one axle of the vehicle to manage the at least one vehicle system.

11. The computer system of claim 1, wherein the at least one vehicle system comprises an anti-lock braking system (ABS), a traction control system, or an axle load distribution system.

12. A vehicle comprising the computer system of any claim 1.

13. A computer-implemented method for estimating a load on a vehicle to manage at least one vehicle system, comprising:
obtaining, by processing circuitry of a computer system, a first load estimate using a first load estimation technique;
obtaining, by the processing circuitry, a second load estimate using a second load estimation technique;
selecting, by the processing circuitry, the first load estimate as the load on the vehicle in response to determining that the first load estimate matches with the second load estimate; and
managing, by the processing circuitry, the at least one vehicle system based on the first load estimate.

14. The method of claim 13, further comprising:
performing the first load estimate technique comprising determining a load based on a suspension force, wherein the suspension force is estimated using a pressure value at a rear axle of the vehicle, a displacement of the rear axle of the vehicle, and a displacement of a front axle of the vehicle.

15. The method of claim 14, wherein performing the first load estimate technique further comprises:
determining another load based on a driveline torque, wherein the driveline torque is estimated using an axle speed of the vehicle, a tire dimension of the vehicle, and a fuel consumption of the vehicle; and
determining the first load estimate by applying a factor of difference between the load determined based on the suspension force and the another load determined based on the driveline torque to the load determined based on the suspension force.

16. The method of any of claim 13, further comprising:
performing the second load estimate technique comprising estimating a suspension force acting on at least one axle of the vehicle.

17. The method of claim 16, wherein performing the second load estimate technique further comprises:
measuring a brake force acting on the at least one axle of the vehicle while the vehicle is decelerating; and
determining the second load estimate on the at least one axle based on the suspension force and the brake force.

18. The method of claim 13, further comprising:
when the first load estimate does not match with the second load estimate:
determining a ratio between the second load estimate and the first load estimate; and
applying the determined ratio to the first load estimate for estimating the load on the at least one axle of the vehicle to manage the at least one vehicle system.

19. A computer program product comprising program code for performing, when executed by the processing circuitry, the method of claim 13.

20. A non-transitory computer-readable storage medium comprising instructions, which when executed by the processing circuitry, cause the processing circuitry to perform the method of claim 13.
